(19) United States
(12) Patent Application Publication
(10) Pub. No.: US 2005/0194568 A1
(43) Pub. Date: Sep. 8, 2005

(54) High image rate supertwisted nematic liquid crystal display element and driving method therefor

(76) Inventors: Wen-Hsien Yang, Kaohsiung (TW); Keng Yuan Chen, Kaohsiung (TW); Kuo-Tai Tsai, Kaohsiung (TW); Kuan-Ting Wu, Kaohsiung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/883,749

(22) Filed: Jul. 6, 2004

(30) Foreign Application Priority Data
Mar. 5, 2004 (TW) 093105981

(51) Int. Cl. C09K 19/52; C09K 19/54

(52) U.S. Cl. 252/299.01; 252/299.5; 428/1.1

(57) ABSTRACT

The present invention is related to a liquid crystal display element and driving method therefor, particularly to a high image rate supertwisted nematic liquid crystal display elements and driving method therefor. By means of a newly introduced crystal formula, a reduced spacing distance between the first and second substrates, an enlarged pretilt angle of alignment layer, and an accelerated frame rate (frame rate: the number of frames displayed per second) of the driving signal, high response rate display is obtained, and thus image retention and flicker are not showed in the liquid crystal display element, so as to display the dynamic image with the effect of high image quality and fast response time.

### FIELD OF THE INVENTION

The present invention is related to a liquid crystal display element and driving method therefor, particularly to a high image rate supertwisted nematic liquid crystal display element and driving method therefor, allowed for displaying the retention free and flicker free dynamic image with the effect of high image quality and fast response time.

### BACKGROUND

Liquid crystal display (LCD) elements have been used as a mainstream product in place of traditional cathode ray tubes (CRTs) gradually in the display market, owing to the features of light weight, small volume, and low power consumption thereof. For various LCD elements, compared with twisted nematic (TN) LCD elements, supertwisted nematic (STN) LCD elements may provide higher contrast ratio, also multi-color display, and substantially lower manufacturing cost thereof than that of thin film transistor (TFT) LCD elements. Thus, the STN LCD element has been widely used in a display module of a palm computer, mobile phone, electronic dictionary, digital camera, electronic gaming, auto vending machine, and so on.

As shown in FIG. 1, the conventional STN LCD elements mainly comprises a first electrode layer 151 and a second electrode layer 153 correspondent with each other, a first alignment film 131, and a second alignment film 133 individually provided in turn between the lower surface of a first glass plate 171 and the upper surface of a second glass plate 173. Between the first alignment film 131 and the second alignment film 133, there is provided with at least one spacing layer 113 in such a way that a plurality of crystal caves 115 may be formed, each crystal cave 115 being filled with a liquid crystal 11 therein. In general, the liquid crystal 11 may be a liquid crystal substance having a chemical structure as formula (f): 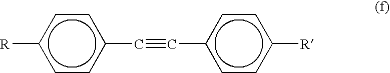
where R and R′ may be a chemical group, such as alkyl group, alkoxide group, and alkene group, etc. Moreover, on the upper surface of the first glass plate 171 and the lower surface of the second glass plate 173, there are further provided with corresponding first and second polarized film 191 and 193, respectively. As a driving signal is inputted via the first electrode layer 151 and the second electrode layer 153, the twist for the angle of the liquid crystals 11 in the crystal caves 115 may be performed so as to control the state of the transparency or opaque for each crystal cave 115, and further display an image on the STN LCD element.

For the conventional TN LCD element, a spacing distance D between the first and second glass plates 171 and 173 is generally set at 5˜6 μm. Under the natural state, i.e. when the voltage is not applied between the first and second electrode layers 151 and 153 of the crystal module, the pretilt angle w is normally set at 4°˜6° (as illustrated in FIG. 2), such that an enlarged viewing angle of the LCD element and proper contrast ratio for image may be obtained.

However, for this conventional STN LCD element, the response time T is generally around 400˜500 ms, due to the composition of the formula for LCD. Therefore, only a driving signal at a lower frame rate (frame rate: the number of frames displayed per second) is allowed for driving. This is simply suitable for displaying static image, and not for displaying dynamic image owing to the condition of motion trail and image retention, resulting in being relatively uncomfortable for viewing dynamic image. Nevertheless, if a driving signal at higher frame rate is used to drive, the image with inferior quality may be caused due to the fact that the response rate could not keep up with the frequency of the driving signal, equally not suitable for viewing dynamic image. This so called response time T means the summation of a rise time T_{R}, required for the rising of the transmittance from 10% to 90% when a turn on voltage is applied, and a fall time T_{F}, required for the falling of the transmittance from 90% to 10% when a turn off voltage is applied, i.e., T=T_{R}+T_{F}, in which the transmittance without applied voltage is defined as 0%, while a saturated transmittance with applied voltage is defined as 100%. Owing to extremely high manufacturing cost, the current TFT LCD element operated at high response rate and allowed for dynamic image is still not suitable for consumer electronics with small panels, such as mobile phones, electronic dictionaries and electronic gamings, for example.

### SUMMARY OF THE INVENTION

To this end, how to design a high image rate supertwisted nematic liquid crystal display element with respect to the above disadvantages in conventional technology, so as to not only relatively speed up the response rate of the liquid crystal thereof in order for raising the quality of image, but also broaden the application field resulting in being suitable for viewing dynamic image, is the key point of the present invention.

Accordingly, it is the primary object of the present invention to provide a high image rate supertwisted nematic liquid crystal display element operated at an accelerated response rate of the liquid crystal for preventing the condition of image retention on the LCD element when viewing dynamic movie, further raising the quality of image, by means of a liquid crystal with new formula, cooperated with a reduced spacing distance between upper and lower substrates, and an enlarged pretilt angle of alignment layer in LCD panel.

It is the secondary object of the present invention to provide a high image rate supertwisted nematic liquid crystal display element with the feature of high imaging rate for avoiding the imperfection of motion trail, by means of a raised frame rate of the driving signal cooperated with the high response rate of the liquid crystal.

It is another object of the present invention to provide a high image rate supertwisted nematic liquid crystal display element with a high response rate of the liquid crystal, and further replace the TFT LCD elements with the high manufacturing cost in order to broaden application field thereof and result in being beneficial for numerous consumers.

### BRIEF DESCRIPTION OF DRAWINGS

FIG. 1 is a structural diagram of a conventional STN LCD element;

FIG. 2 is a diagram of a pretilt angle of liquid crystal molecules in the conventional structural illustrated in FIG. 1, where an electric field is not applied yet.

FIG. 3 is a structural diagram of a STN LCD element according to one preferred embodiment of the present invention;

FIG. 4 is a diagram of a pretilt angle of liquid crystal molecules according to the embodiment of the present invention in FIG. 3, where an electric field is not applied;

FIG. 5 is a correlation diagram of the driving frequency versus the transmittance when the LCD element of the present invention is driven by a driving signal with a frame rate at 60 Hz;

FIG. 6 is a relation diagram of the driving frequency versus the transmittance when the LCD element of the present invention is driven by a driving signal with a frame rate at 120 Hz;

FIG. 7 is a flow diagram of driving at PC end for the STN LCD element of the present invention; and

FIG. 8 is a flow diagram of driving at PC end for the high image rate STN LCD module (LCM) element of the present invention,

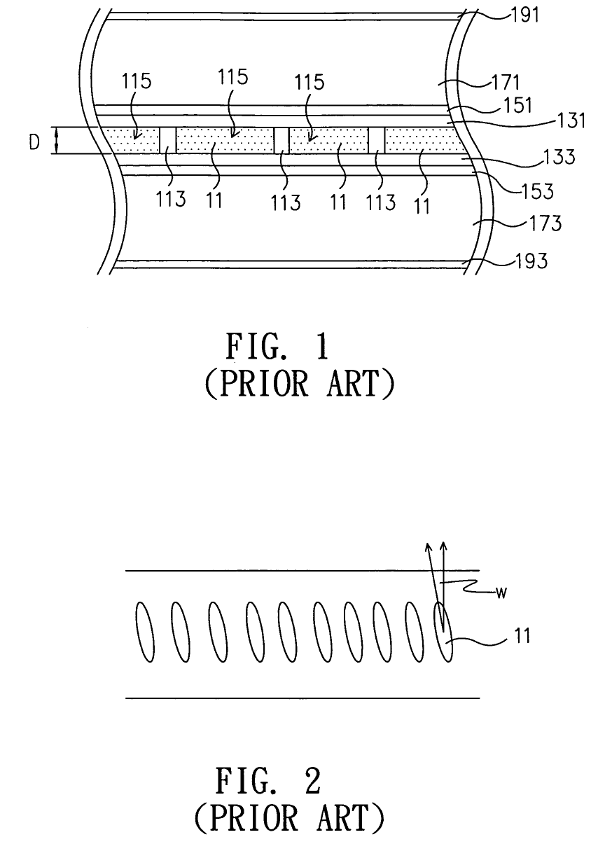

### DETAILED DESCRIPTION

The structural features and the effects to be achieved may further be understood and appreciated by reference to the presently preferred embodiments together with the detailed description.

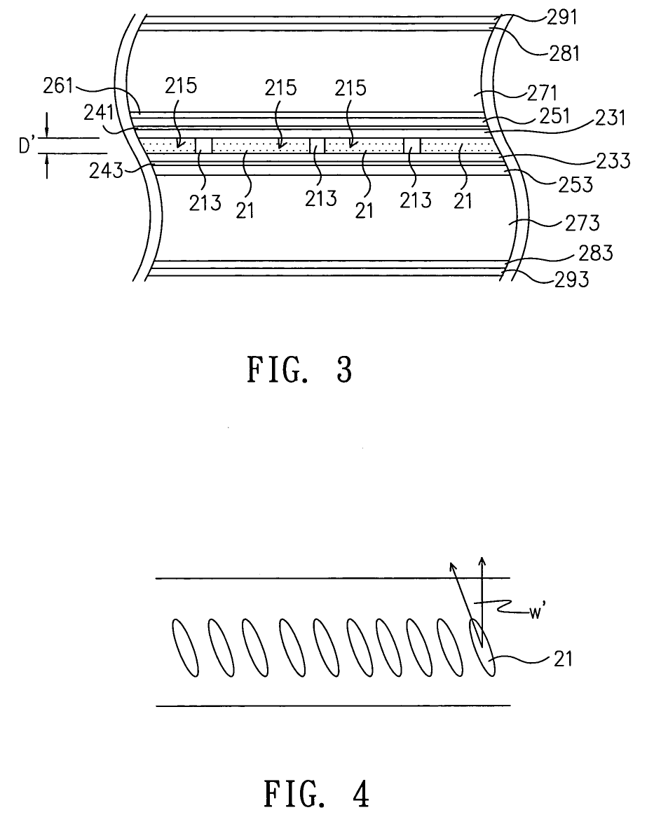

Referring to FIGS. 3, firstly, there is shown a structural diagram according to one preferred embodiment of the present invention. As illustrated in this figure, the main structure comprises a first electrode layer 251 and a second electrode layer 253 correspondent with each other, a first alignment film 231, and a second alignment film 233 individually formed in turn between a first substrate 271 and a second substrate 273. Between the first alignment film 231 and the second alignment film 233, at least one spacing layer 213 is used to form a plurality of crystal caves 215, each crystal cave 215 being filled with an appropriate amount of liquid crystal 21, in which a spacing distance D′ between the first substrate 217 and the second substrate 273, in comparison with the spacing distance D (5˜6 μm) in the conventional technology, may be substantially reduced to 2˜5 μm. As for the formula of the liquid crystal 21, at least one compound having a chemical structure as formula (A) is added: 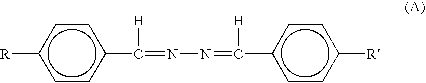
Where R and R′ may be CN, alkyl group, alkoxide group, alkoxide acyl group, and carbalkoxyl group, respectively. Moreover, the compound having a chemical structure as formula (B) may be also added to the formula for the liquid crystal 21. 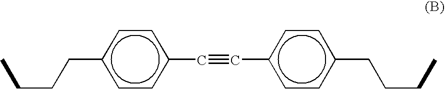
Furthermore, a first phase compensation film 281 and a second phase compensation film 283 corresponding with each other, a polarized film 291, and a second polarized film 293 are individually provided in turn between the upper surface of the first substrate 271 and the lower surface of the second substrate 273.

When used as a multi-color or full color display, a color filter 261 may be further provided between the first substrate 271 and the first electrode layer 251. Moreover, between the first electrode layer 251 and the first alignment film 231, there may be provided with a first protective layer 241 in order for isolating the first electrode layer 251 with the first alignment film 231, avoiding interaction therebetween and further prolonging the service life of the element. Also, a second protective layer 243, of course, may be provided between the second electrode layer 253 and the second alignment film 233, for avoiding interaction therebetween and further prolonging the service life of the element.

Furthermore, a polymer, such as polyimide and polyethylene alcohol, for example, may be used for the first alignment film 231 and the second alignment film 233. Subsequently, by means of the method of rubbing alignment or molecule molding cooperated with a high temperature bake of 150˜280° C., the first alignment film 231 and the second alignment film 233 are made with liquid crystal molecule presented as pretilt angle w′ of 4°˜8° (as illustrated in FIG. 4). Naturally, a light alignment process may be also used to produce the first and second alignment films 231 and 233. This so called light alignment process means a technology including irradiating the first and second alignment films 231 and 233 at predetermined angle by a polarized beam having a wavelength within a specific range, in such a manner that the polymerization reaction or cracking reaction may be generated in specified directions in the first and second alignment films 231 and 233, followed by rubbing art to form a specified alignment orientation.

The compound with a chemical structure as formula (A) introduced by the present invention may have a feature of the shortened response time; while the compound with a chemical structure as formula (B) may have a higher optical anisotropy Δn. In the experiment of the present invention, by the mixture of compounds as formulas (A) and (B) with an appropriate ratio for obtaining the best imaging effect, it is found that a significantly reduced response time, while combining a desirable contrast ratio and wide viewing angle for having a decent image quality, if the optical anisotropy Δn is provided between 0.13 and 0.24, as well as the pretilt angle of alignment layer is provided between 4°˜8°. For the mixed liquid crystal 21, a superior effect for response time of 60˜200 (ms) may be obtained, even though the viscosity coefficient η thereof is provided between 10 and 50 cps. In this extremely high response rate, a high-quality image with the combination of a desirable contrast ratio and a considerable viewing angle is obtained.

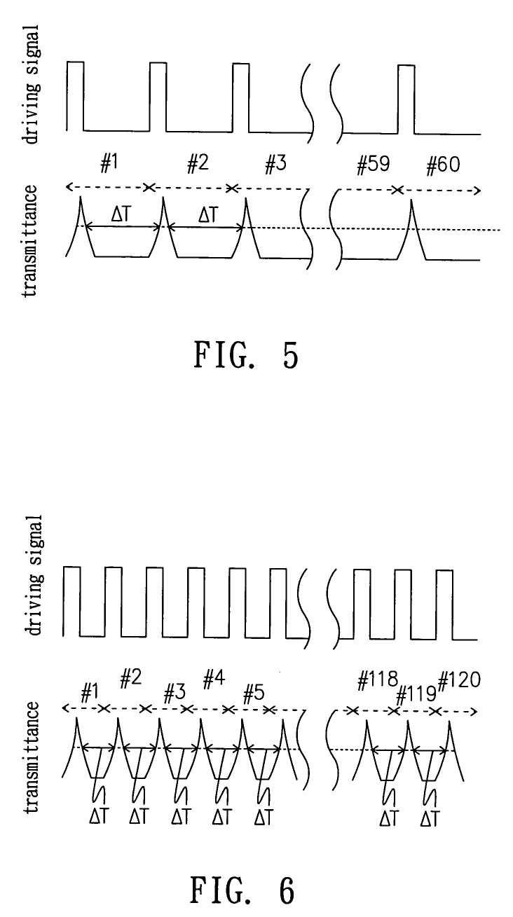

For the cooperation with this liquid crystal formula allowed for high response rate, the frame rate (frame rate: the number of frames displayed per second) of the driving signal may be also raised significantly, in order for cooperating with this response rate of the liquid crystal, whereby the object of stable picture without flicker may be obtained. Referring to FIG. 5, there is shown a correlation diagram of the driving frequency versus the transmittance when the LCD element of the present invention is driven by a driving signal with a frame rate at 60 Hz. As illustrated in this figure, between any two of adjacent frames, such as frame #1 and frame #2, the time interval ΔT when the transmittance is lower than a predetermined transmittance may be longer. Thereby, a misgiving of flickering picture may be caused.

To solve this problem, the frame rate of the driving signal of the present invention may be raised for enhancing the display quality of the picture. Referring to FIG. 6, there is shown a correlation diagram of the driving frequency versus the transmittance when the LCD element of the present invention is driven by a driving signal with a frame rate at 120 Hz. As illustrated in this figure, as the frame rate increases, the waveform of the transmittance may surge, like relay race, between any two of adjacent frames, such that the time interval ΔT when the transmittance is lower than the predetermined transmittance may be further significantly reduced between any two of adjacent frames, such as frame #1 and frame #2. Thereby, a misgiving of flickering picture may be avoided. At the predetermined frame rate of 80˜120 Hz-, it is verified from the experiment that a flicker free picture with superior contrast ratio as well as a continuously dynamic picture without image retention is presented simultaneously. Thus, the best image quality can be achieved.

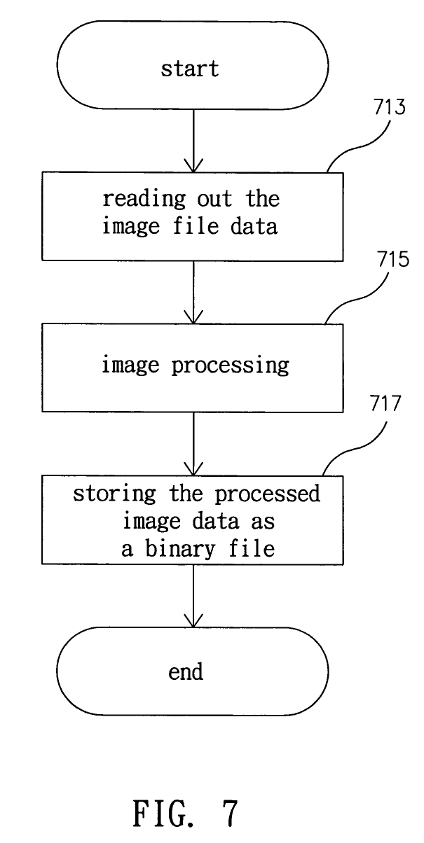

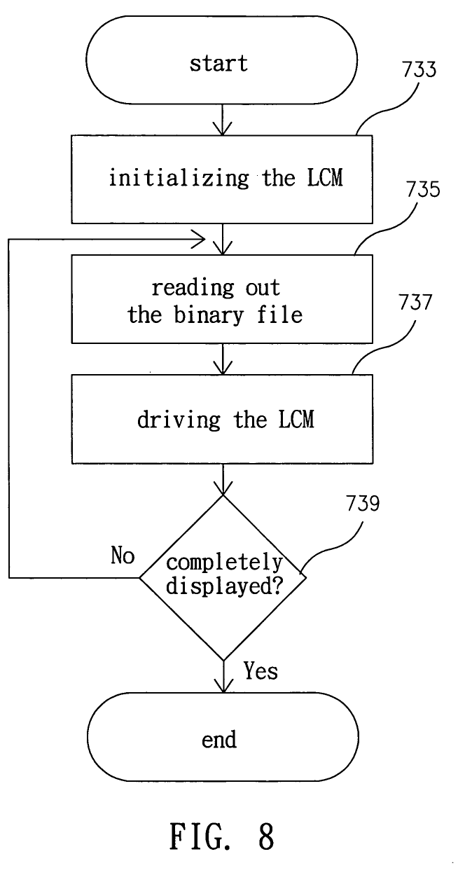

Moreover, in terms of the driving method of the present invention, a driving method for PC end and a driving method for STN LCD element end are included. Collectively referring to FIGS. 7 and 8, there are shown a flow diagram of driving at PC end for the high image rate STN LCD element of the present invention, and a flow diagram of driving at the element end for the STN LCD element thereof, respectively. As illustrated in these figures, the driving procedure at PC end mainly comprises the steps in:

Step 713: firstly reading out the image file data from CD-ROM, hard disk, or other storage devices;
Step 715: performing image processing with respect to the read out image file data;
Step 717: storing the processed image data as a binary file in order to form a one-sheet image.

Subsequently, the driving procedure at the element end of the STN LCD mainly comprises the steps in:
Step 733: initializing the element end of the STN LCD;
Step 735: reading out the one-sheet image presented as a binary file;
Step 737: driving the element end of the STN LCD so as to display the one-sheet image presented as a binary file on the high image rate STN LCD element, in which the one-sheet image read from the PC end may be multi-displayed in the LCD module, such as the one-sheet image may be displayed twice or three times, differently from the method in conventional technology where one-sheet image is displayed once only; in other words, the condition of flickering picture or motion trail may be avoided due to the shortened time interval between two successive images resulted from a raised frame rate; and
Step 739: detecting whether the stored binary file has been completely displayed. If so, this operation of image reading and displaying is ended; if not, the procedure will go back to step 735 and continue to read out the next image, followed by repeating this procedure until all the stored binary files are displayed.

By means of the formula of the present invention, the response time may be reduced to 60˜200 ms significantly shorter than 400˜500 ms in the conventional technology. Further combined with the driving signal at high frame rate of 80˜240 Hz, neither image retention and motion trail, nor flickering image may be generated again, while a considerably high image contrast ratio and a relatively wide viewing angle may be also obtained, when dynamic image is played in this manner. Therefore, the high image STN LCD element of the present invention may be applied to the LCD module of an electronic device, such as LCD computer monitor, notebook, palm computer, handheld computer, mobile phone, reader, electronic book, personal digital assistant, cash register, stock manager, digital camera, LCD projector, LCD television, electronic gaming, precision measurement instrument, DVD player, automobile navigation system, copy machine, video game machine, and auto vending machine. Not only wide application field, but also dynamic image with high quality can be obtained, such that expensive products, for instance, thin film transistor (TFT) LCD element, etc., may be replaced to be further beneficial for numerous consumers.

1. A high image rate supertwisted nematic (STN) liquid crystal display (LCD) element, the main structure thereof comprising:
a first substrate and a second substrate;
at least one first electrode layer and at least one second electrode layer correspondingly formed on the lower surface of said the first substrate and the upper surface of said the second substrate, respectively;
at least one first phase compensation film and at least one second phase compensation film correspondingly formed on the upper surface of said the first substrate and the lower surface of said the second substrate, respectively;
at least one first alignment film and at least one second alignment film correspondingly formed on the lower surface of said the first electrode layer and the upper surface of said the second electrode layer, respectively;
at least one first polarized film and at least one second polarized film correspondingly formed on the upper surface of said the first phase compensation film and the lower surface of said the second phase compensation film, respectively;
at least one spacing layer disposed between said the first alignment film and said the second alignment film, by which a plurality of crystal caves are formed; and
a liquid crystal filled in said plurality of crystal caves, said liquid crystal at least including a substance with a chemical structure as formula (A): 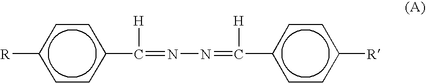
wherein r and r′ is selected from the group consisting of CN, alkyl group, alkoxide group, alkoxide acyl group, carbalkoxyl group, and the combination thereof; and a pretilt angle of said alignment layer is allowed to be changed for further changing transmittance in order to form image when a driving signal is fed through said the first electrode layer and said the second electrode layer.

2. The STN LCD element according to claim 1, wherein a spacing distance between said the first substrate and said the second substrate is set between 2 μm and 5 μm.

3. The STN LCD element according to claim 1, wherein said liquid crystal further comprises a substance with a chemical structure as formula (B).

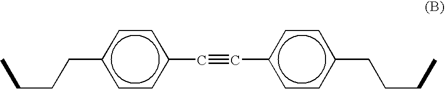

4. The STN LCD element according to claim 1, wherein an optical anisotropy Δn of said liquid crystal is set between 0.13 and 0.24.

5. The STN LCD element according to claim 1, wherein a pretilt angle of said alignment layer is set between 4° and 8°.

6. The STN LCD element according to claim 1, wherein the viscosity coefficient η of said liquid crystal is set between 10 cps and 50 cps.

7. The STN LCD element according to claim 1, wherein a response period of time said liquid crystal is set between 60 ms and 200 ms.

8. The STN LCD element according to claim 1, wherein a first protective layer is further provided between said the first electrode layer and said the first alignment film, while a second protective layer is further provided between said the second electrode layer and said the second alignment film.

9. The STN LCD element according to claim 1, wherein a color filter is further provided between said the first substrate and said the first electrode layer.

10. The STN LCD element according to claim 1, wherein the frame rate of said the driving signal is set at 80˜240 Hz.

11. The STN LCD element according to claim 1, wherein said the first alignment film and said the second alignment film are made by a photo-alignment method, respectively.

12. The STN LCD element according to claim 1, wherein said the first alignment film and said the second alignment film are made by rubbing alignment layer and thermal bake methods.

13. A driving method for driving the STN LCD element according to claim 1 including a driving method for PC end and a driving method for STN LCD element end, said the driving method for PC end mainly comprising the steps in:
reading out image data;
performing image processing; and
storing the processed image data as a binary one-sheet image;
while said the driving method for STN LCD element end mainly comprising the steps in:
Step 1: initializing a STN LCD element;
Step 2: reading out said one-sheet image stored as binary;
Step 3: driving said STN LCD element in order to form said a binary one-sheet image on said STN LCD element several times;
Step 4: going back to Step 2 in order to read out the next one-sheet image, then arriving at Step 3, and repeating in this turn until the procedure is ended if there is no remaining one-sheet image allowed to be read.

14. The driving method according to claim 13, wherein said there is one-sheet image allowed to be formed on said STN LCD element more than twice.
